(19) United States
(12) Patent Application Publication
(10) Pub. No.: US 2022/0057315 A1
(43) Pub. Date: Feb. 24, 2022

(54) PARTICLE MONITORING

(71) Applicant: Hewlett-Packard Development COMPANY, L.P., Spring, TX (US)

(72) Inventors: Fausto D'Apuzzo, Palo Alto, CA (US); Viktor Shkolnikov, Palo Alto, CA (US); Yang Lei, Palo Alto, CA (US)

(73) Assignee: Hewlett-Packard Development Company, L.P., Spring, TX (US)

(21) Appl. No.: 17/312,231

(22) PCT Filed: Jan. 23, 2019
(86) PCT No.: PCT/US2019/014817

§ 371 Date: Jun. 9, 2021

(51) Int. Cl. G01N 15/06

(52) U.S. Cl. CPC G01N 15/0656; G01N 2015/0065; G01N 2015/0693

(57) ABSTRACT

A particle monitoring system may include a volume for containing a fluid in which particles are suspended, a photosensitive layer, a light encoding layer sandwiched between the volume and the photosensitive layer and electrodes to apply an electric field to the fluid within the volume and proximate the photosensitive layer.

### BACKGROUND

Particles, both organic and inorganic, are often monitored and evaluated for a variety of purposes. For example, organic particles, such as cells or cellular microorganisms, are often evaluated to identify diseases or to evaluate the health of an organism. Inorganic particles may be monitored and evaluated to identify pollution or environmental hazards.

### BRIEF DESCRIPTION OF THE DRAWINGS

FIG. 1 is a sectional view schematically illustrating portions of an example particle monitoring system and particle monitor.

FIG. 2 is a flow diagram of an example particle monitoring method.

FIG. 3 is a sectional view illustrating portions of an example particle monitoring system.

FIG. 4 is a flow diagram of an example particle monitoring method.

FIG. 5 is a diagram illustrating one example implementation of the particle monitoring method of FIG. 4.

FIG. 6A is a top perspective view of portions of an example light encoding layer.

FIG. 6B is a sectional view of portions of an example light encoding layer.

FIG. 7 is a top view of portions of an example patterned opaque layer adjacent an example electrode.

FIG. 8 is a top view of portions of an example patterned opaque layer adjacent an example electrode.

FIG. 9 is a top view of portions of an example patterned opaque layer adjacent an example electrode.

FIG. 10 is a top view of portions of an example patterned opaque layer adjacent an example electrode.

FIG. 11 is a top view of portions of an example patterned opaque layer adjacent an example electrode.

FIG. 12 is a top view of portions of an example patterned opaque layer adjacent an example electrode.

FIG. 13 is a sectional view of portions of an example light encoding layer.

FIG. 14A is a top view of portions of example electrodes on an example light encoding layer.

FIG. 14B is a side view of the example electrodes on the example light encoding layer of FIG. 14A.

FIG. 15 is a top view of portions of example electrodes on an example light encoding layer.

FIG. 16 is a top view of portions of example electrodes on an example light encoding layer.

FIG. 17 is a flow diagram of an example method for forming an example particle monitor.

FIGS. 18A, 18B, 18C, 18D, 18E, 18F, 18G, 18H, 18I and 18J are sectional views illustrating an example method for forming portions of an example particle monitor.

FIG. 19 is a sectional view schematically illustrating an example particle monitoring system and particle monitor.

FIG. 20 is a sectional view schematically illustrating an example particle monitoring system and particle monitor.

FIG. 21 is a perspective view schematically illustrating an example particle monitoring system and particle monitor.

FIG. 22A is a sectional view schematically illustrating portions of an example particle monitoring system.

FIG. 22B is a bottom plan view of the example particle monitoring system taken along line 22B-22B of FIG. 22A.

FIG. 22C is a sectional view of the example particle monitoring system taken along line 22C-22C of FIG. 22B.

FIG. 22D is a sectional view of the example particle monitoring system taken along line 22D-22D of FIG. 22B.

FIG. 22E is an enlarged view of FIG. 22B taken along line 22E of FIG. 22B.

Throughout the drawings, identical reference numbers designate similar, but not necessarily identical, elements. The FIGS. are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example particle monitoring systems, particle monitoring methods and methods for fabricating a particle monitoring device. The disclosed particle monitoring systems, particle monitoring methods and particle monitoring device fabrication methods have a significantly lower cost and construction than those systems that rely upon precision stepping, optics and/or high-sensitivity cameras. The disclosed systems and methods may further facilitate higher particle monitoring throughput and accuracy.

The disclosed particle monitoring systems and particle monitoring methods use an electrical field to manipulate a particle, suspended in a fluid, before or while the particle is sensed by light passing through a light encoding layer to a photosensitive layer. Electrical signals from the photosensitive layer indicate a characteristic of the particle. In one implementation, the electric field draws the particle into close proximity with the light encoding layer to better sense the particle. In one implementation, the electric field alternatively or additionally rotates the particle. In one implementation, the rotational response of the particle to the electric field is sensed to identify or classify the particle or is used to distinguish the particle from other particles. In some implementations, the rotation response of the particle to different electric fields, such as different frequencies of an electric field, is sensed to identify or classify the particle or is used to distinguish the particle from other particles. In one implementation, the particle is imaged while in close proximity to the light encoding layer and photosensitive layer and/or while rotating.

In some implementations, the light encoding layer comprises a two dimensional separable layer such as a layer with a varying lattice pitch. The pitch may be periodic for ease of fabrication with interference photolithography. The pitch may be quasi periodic to allow enhanced image reconstruction. In some implementations, the pitch of the encoding layer is optimized along edges of the electrodes to suppress background noise. In some implementations, the light encoding layer may be a 2D non-separable pattern formed from a randomized lattice. Such random patterns facilitate organic patterns with self-assembly mask fabrication to reduce fabrication costs and complexity. As with the 2D separable patterns, the non-several patterns are optimized along the edges of the electrodes to suppress background noise.

Disclosed is an example particle monitoring system may include a volume for containing a fluid in which particles are suspended, a photosensitive layer, a light encoding layer sandwiched between the volume and the photosensitive layer and electrodes to apply an electric field to the fluid within the volume and proximate the photosensitive layer.

Disclosed is an example particle monitoring method. The method may comprise supplying a volume of fluid containing a suspended particle, applying an electric field to the suspended particle, and sensing light, that has passed through the electric field, around the suspended particle and through a light encoding layer, with a photosensitive layer.

Disclosed is an example particle monitoring device fabrication method. The fabrication method may comprise patterning a light encoding layer, supporting the light encoding layer on a photosensitive layer, forming a volume proximate the light encoding layer and proximate the photosensitive layer and forming electrodes proximate the volume such that the electrodes are chargeable to form an electric field within the volume proximate the light encoding layer and proximate the photosensitive layer.

FIG. 1 is a side view schematically illustrating portions of an example particle monitoring system 10 comprising particle monitor 20. As a result, the systems and methods may have a significantly lower cost and construction than those systems that rely upon precision stepping, optics and/or high-sensitivity cameras. Particle monitoring system 10 may further facilitate higher particle monitoring throughput and accuracy. Particle monitoring system 10 uses an electrical field to manipulate a particle, suspended in a fluid, before or while the particle is sensed by light passing through a light encoding layer to a photosensitive layer. Particle monitor 20 comprises volume 24, photosensitive layer 28, light encoding layer 32 and electrodes 36.

Volume 24 is to contain a fluid 40 in which the particle or particles 42 (shown in broken lines) to be monitored are to be suspended. Volume 24 may be in the form of a channel through which the fluid with the suspended particle or particles flows or may be in the form of a reservoir or well. Volume 24 is exposed to light, such as ambient light or light from a controlled light source. The light may be visible light, ultraviolet light, infrared light or may have other wavelengths. In one implementation, volume 24 may be bound by transparent sides, a transparent ceiling and/or a transparent light encoding layer 32 through which the light passes so as to impinge particles 42 and ultimately passes through light encoding layer 32 to impinge photosensitive layer 28.

Photosensitive layer 28 comprises a layer of material or materials that react to impinging light. Layer 28 itself may be composed of multiple layers. In one implementation, photosensitive layer 28 comprises an electronic light sensor referred to as a charge coupled device or CCD. The CCD may be formed from pixels such as p-doped metal-oxide-semiconductors capacitors. Such capacitors convert incoming photons in electron charges at the semi-conductor-oxide interface, were in such charges are read to detect light impingement at the individual pixels. In other implementations, photosensitive layer 20 may comprise other layers are devices that are sensitive to the impingement of photons or light.

Light encoding layer 32 comprises a layer or multiple layers that have a pattern of opaque or light-blocking portions to encode light passing through layer 32 and impinging photosensitive layer 28. Light encoding layer 32 facilitate sensing movement and/or scale of the particle being sensed or monitored through the sensing of light that is passed through the light encoding layer to impinge photosensitive layer 28. Light encoding layer 32 may be in the form of an amplitude mask. For example, in one implementation, light encoding layer 32 may comprise a transparent substrate with a patterned metallic opaque layer and an overlying insulating layer. In one implementation, light encoding layer 32 may comprise a stack formed by a polymethylmethacrylate (PMA) substrate an opaque aluminum layer and an insulating layer of SiO2. In one implementation, light encoding layer 32 may comprise a diffuser or a substrate having an non-homogenous optical density.

As will be described hereafter, in some implementations, the light encoding layer 32 may comprise a two dimensional separable layer such as a layer with a varying lattice pitch. The pitch may be periodic for ease of fabrication with interference photolithography. The pitch may be quasi periodic to allow enhanced image reconstruction. In some implementations, the pitch of the encoding layer is optimized along edges of the electrodes to suppress background noise. In some implementations, the light encoding layer may be a 2D non-separable pattern formed from a randomized lattice. Such random patterns facilitate organic patterns with self-assembly mask fabrication to reduce fabrication costs and complexity. As with the 2D separable patterns, the non-separable patterns are optimized along the edges of the electrodes to suppress background noise.

Electrodes 36 comprise electrically conductive structures arranged in pairs or sets in which are placed at different electrical charges so as to form an electrical field within volume 24. Electrodes 36 may be directly adjacent to volume 42 or may be spaced from volume 42, but in sufficient proximity to form an electric field within volume 24. The electric field formed by electrodes 36 is to manipulate the particle or particles suspended within the fluid contained within volume 24. In one implementation, the electric field is controlled so as to attract or draw the particle or particles, using electrophoresis, into closer proximity to light encoding layer 32 and photosensitive layer 28. Drawing the particle or particles into closer proximity with photosensitive layer 28 provides enhanced sensing and/or imaging of the particular particle or particles.

In one implementation, the electric field is controlled so as to rotate the particle, using dielectrophoresis. Rotation of the particle or particles alters the transmission of light through light encoding layer 32 to photosensitive layer 28. Signals from photosensitive layer 28 may be used to determine rotational characteristics, such as spin rate, of the particle in response to the electric field. In one implementation, the rotational response of the particle to the electric field is sensed to identify or classify the particle or is used to distinguish the particle from other particles. In some implementations, the rotation response of the particle to different electric fields, such as different frequencies of an electric field, is sensed to identify or classify the particle or is used to distinguish the particle from other particles. Such identification or classification is achieved with a less reliance or without any reliance upon precision stepping, optics and/or high-sensitivity cameras.

As shown by solid lines, in one implementation, electrodes 36 may be located on an opposite side of volume 24 as compared to light encoding layer 32 and photosensitive layer 28. In such an implementation, light may be provided or transmitted to volume 42 through electrodes 36, such as where electrodes 36 are formed from a transparent electrically conductive material such as indium tin oxide. In other implementations, likely provided through gaps electrodes 36 or through the sides or ends of volume 24.

As shown by broken lines, in other implementations, system 10 may comprise electrodes 36′. Electrodes 36′ are similar to electrodes 36, but are sandwiched between volume 24 and light encoding layer 32. Electrodes 36′ are formed so as to permit the transmission of light from volume 24, through electrodes 36′ and through light encoding layer 32 to photosensitive layer 28. In one such implementation, electrodes 36′ are formed from a transparent electrically conductive material such as indium tin oxide.

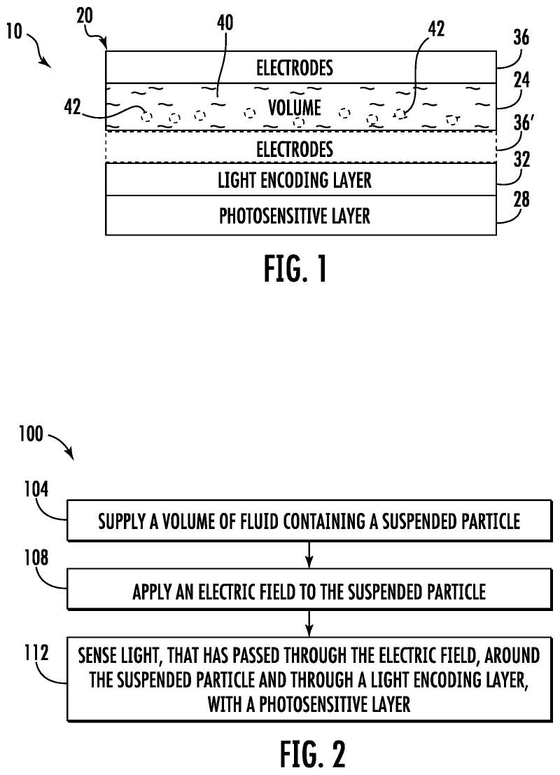

FIG. 2 is a flow diagram of an example particle monitoring method 100. Method 100 may further facilitate higher particle monitoring throughput and accuracy. Method 100 uses an electrical field to manipulate a particle, suspended in a fluid, before or while the particle is sensed by light passing through a light encoding layer to a photosensitive layer. Although method 100 is described in the context of being carried out by system 10 and particle monitor 20, it should be appreciated that method 100 may likewise be carried out with any of the following described particle monitoring systems or similar particle monitoring systems.

As indicated by block 104, a volume of a fluid containing a suspended particle is provided or supply. This volume of fluid may be contained within a reservoir or may be supplied through a passenger channel. The particle may be inorganic or may be organic, such as a cell.

As indicated by block 108, an electric field is applied to the suspended particle. The electric field may be formed by electrodes 36, described above. In one implementation, the electric field is such that it draws or otherwise moves the particle towards a photosensitive layer. In one implementation, the electric field is such that it additionally or alternatively rotates the particle.

As indicated by block 112, light that has passed through the electric field, around the suspended particle and through a light encoding layer is sensed with the photosensitive layer. The sensed light may be used to determine characteristics of the particle. In one implementation, the sensed light may be utilized to image or construct an image two-dimensional or three-dimensional, of the particle. In another implementation, the sensed light may be utilized to determine rotational characteristics of the particle. Different particles having different particle compositions may exhibit different rotational characteristics in response to an applied electric field or in response to multiple different applied electric fields.

The different rotational characteristics may be utilized to identify or classify the particle. For example, in one implementation, such signals may be transmitted to a processing unit following instructions in a non-transitory computer-readable medium. The processing unit may determine the rotational characteristics from the sensed light as detected by the photosensitive layer and may compare the detected rotational characteristics with predetermined rotational characteristics of identified particles. The particle being monitored may be classified identified as a type of particle in response to the particle being monitored having a rotational characteristic that is the same or substantially similar to the rotational characteristics of the prior identified particle of the particular type.

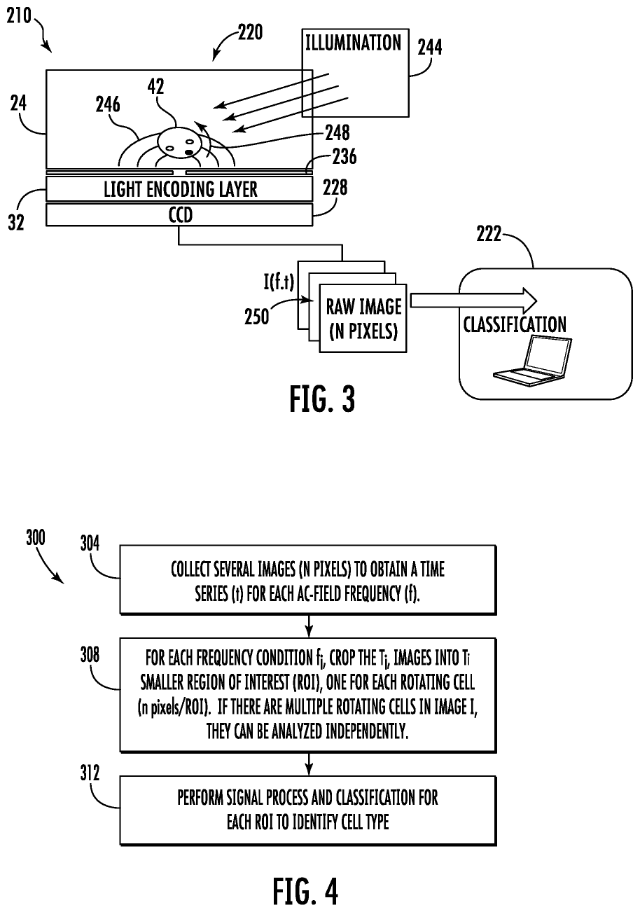

FIG. 3 is a diagram schematically illustrating portions of an example particle monitoring system 210. Particle monitoring system 210 identifies a classify the particle based upon rotational characteristics of the particle in response to the application of different electrical fields, different electrical fields having different frequencies. Particle monitoring system 210 comprises particle monitor 220 and particle classifier 222.

Particle monitor 220 is similar to particle monitor 20 except that photosensitive layer 28 is specifically illustrated as comprising photosensitive layer 228 in the form of a charge coupled device and has further comprising electrodes 236 sandwiched between volume 24 and light encoding layer 32 (each of which is described above). In the example illustrated, particle monitor 220 additionally comprises an illumination source to 44 for illuminating an example particle 42 within volume 24. As shown by FIG. 3, electrodes 236 are placed at different electrical charges so as to form an electric field 246 that draws particle 42 towards electrodes 236 and light encoding layer 32. The electric field alternates or changes so as to further induce rotation of particle 42 as indicated by arrow 248.

Light from illumination source 244 passes through electrodes 236, which are transparent, passes through the light transmissive portions of light encoding layer 32 and impinge the photosensitive layer 228. As schematically illustrated, multiple images 250 of particle 42 are sensed as it rotates while being suspended within a solvent within volume 24. Each image may be formed from multiple smaller pixels.

Classifier 222 comprises a processing unit and a non-transitory computer-readable medium that contains instructions for directing the process to identify and/or classify the particle 42 based upon the sensed images and their smaller pixels. Classifier 222 analyzes the images and pixels by comparing such pixels to determine rotational characteristics of particle 42. The rotational characteristics are compared to predetermined rotational characteristics of identified particles (stored in a database or lookup table). The particle being monitored may be classified identified as a particular type of particle in response to the particle being monitored having a rotational characteristic that is the same or substantially similar to the rotational characteristics of the prior identified particle of the particular type.

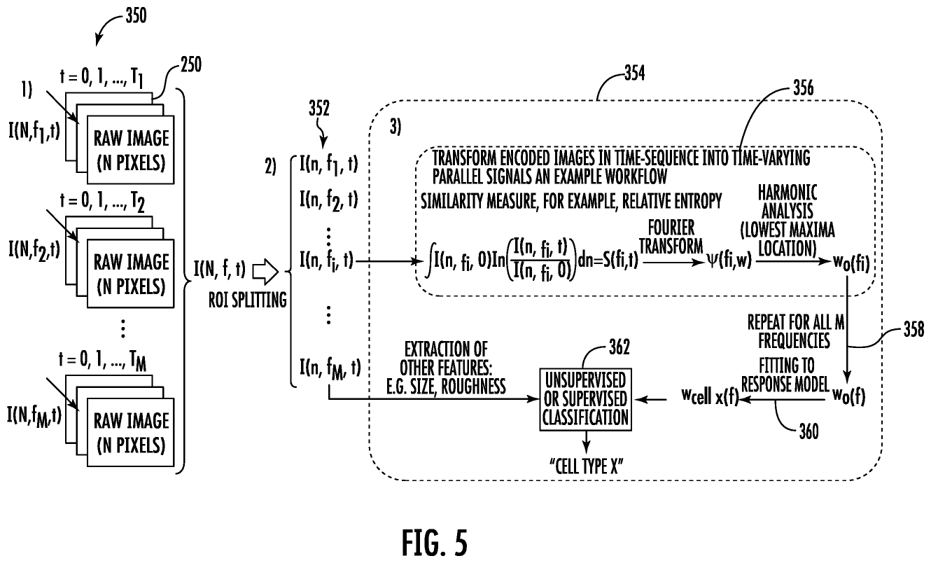

FIG. 4 is a flow diagram of an example particle monitoring and classification method 300 that may be carried out by classifier 222 as part of system 210. FIG. 5 further schematically illustrates the carrying out of method 300. As indicated by block 304 and illustrated by action 350 (1) in FIG. 5, classifier 222 collects several images 250 of N pixels to obtain a time series (t) for each AC-field frequency (f).

As indicated by block 308 and action 352 (2) in FIG. 5, for each frequency condition fi, classifier 222 crops the Ti images into Ti smaller regions of interest (ROI), one for each rotating cell (N pixels/ROI). In circumstances where there are multiple rotating cells in an image I, the cells may be analyzed independently.

As indicated by block 312 and indicated by action 354 (3) in FIG. 5, classifier 222 performs signal processing and classification for each ROI to identify the cell type. As indicated by block 356, in the example shown in FIG. 5, the encoded images in time sequence are transformed into periodic time-varying parallel signals, and then to the cell rotation speed. The periodic time-varying signal represents the similarity between a reference cell image patch at t0 and image patches for the same cell at all other times. The frequency of the periodic time-varying signal, w0, represents the speed of cell rotation. For each frequency fi, we compute the corresponding w0 value. As indicated by arrow 358, the transformation repeated for all of the different M frequencies. As indicated by arrow 360, the results are then fitted to a response model, which might match the response model for certain cell type. As indicated by block 362, the response model along with other features extracted from images, such as size and roughness may be utilized then identify a classification for each of the cells; i.e., a first classification for first cell, a second different classification for a second cell and so on.

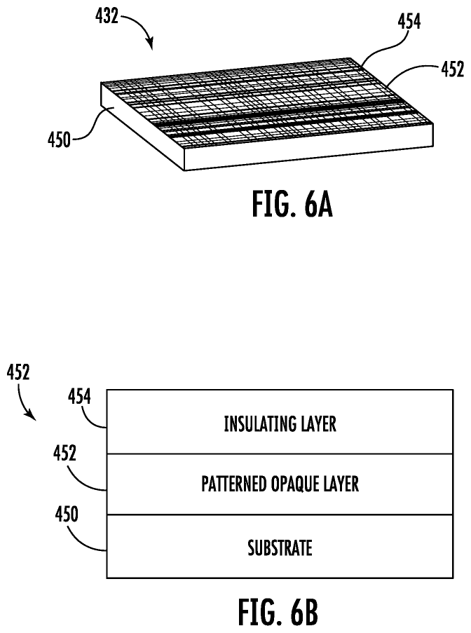

FIGS. 6A and 6B illustrate an example light encoding layer 432 which may be utilized as light encoding layer 32 in particle monitor 20, in particle monitor 220, or in any of the following described particle monitors. Light encoding layer 432 facilitates sensing movement and/or scale of the particle being sensed or monitored through the sensing of light that is passed through the light encoding layer 432 to impinge photosensitive layer 28 or layer 228. Light encoding layer 32 may be in the form of an amplitude mask. Light encoding layer 432 comprises substrate 450, patterned opaque layer 452 and insulating layer 454.

Substrate 450 comprises a layer of transparent material that serves as a foundation supporting patterned opaque layer 452 and insulating layer 454. In one implementation, substrate 450 may be formed from a polymer or a glass. In one implementation, substrate 450 may be formed from PMMA. In other implementations, substrate 450 may be formed from other transparent materials.

Patterned opaque layer 452 comprises a layer of opaque material, material that blocks the transmission of the frequency or range of frequencies of the electromagnetic radiation or light that is sensed by photosensitive layer 28 when sensing particles, such as particles 42 (shown in FIG. 1). Patterned opaque layer 452 comprises portions of block light and portions that transmit light. In one implementation, patterned opaque layer 452 comprises a patterned metallic opaque layer. In one implementation, patterned opaque layer 452 may comprise a light blocking or opaque metallic film or layer such as an opaque aluminum.

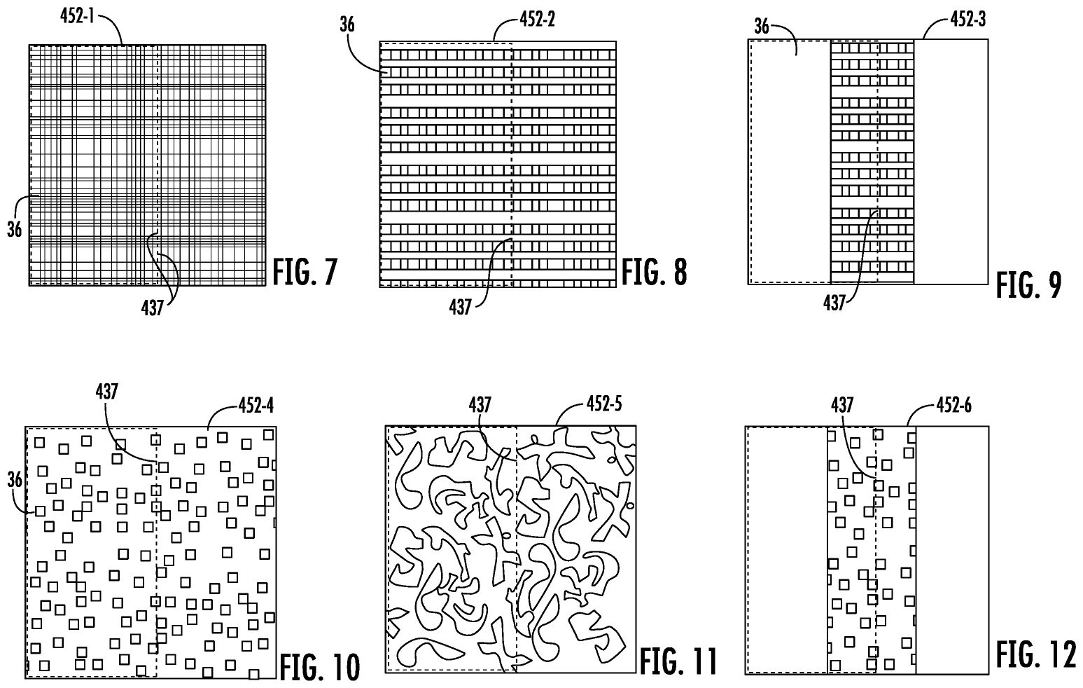

In one implementation, patterned opaque layer 452 has a periodic or quasi periodic latticed pitch. FIGS. 7, 8 and 9 illustrate different examples of patterned opaque layer 452-1, 452-2, 452-3 having a periodic or quasi periodic latticed pitch. The periodic pitch of layers 452-1, 452-2 and 452-3 facilitate ease of fabrication with interference photolithography. As shown by such figures, the patterns are optimized along electrode edge 437 of electrode 36 (shown as a transparent electrode overlying a portion of the underlying pattern) so that the signal is only coming from the region around the electrodes (where the cells or particles of interest are spinning), thus suppressing background noise.

In another implementation, patterned opaque layer 452 has a randomized organic lattice. The random nature the lattice may result in the images being non-separable with respect to their two dimensions. This means that the image reconstruction algorithm is more computationally intensive as it cannot be reduced in dimensionality. FIGS. 10, 11 and 12 illustrate different examples of non-separable patterned opaque layers 452-4, 452-5, 452-6. Patterned opaque layer 452-4 is an example of a randomized lattice. Patterned opaque layers 452-5 and 452-6 are examples of an organic arrangement of lattices for the mask. Although such randomized organic lattices may lack the image reconstruction characteristics of periodic or quasi periodic patterns, possibly involving higher image reconstruction computation overhead, such randomized inorganic patterns may be more easily fabricated. As with layers 452-1, 452-2 and 452-3, layers 452-4, 452-5 and 4529-6 are optimized along the edges 36 of the electrodes 36 to suppress background noise. Because the image may be dimensionally reduced, the image reconstruction algorithm is less computationally intensive, conserving computing resources.

Insulating layer 454 comprises a layer or film of dielectric material, insulating the metallic material of patterned opaque layer 452 from electrodes 36′ or electrodes 236. Insulating layer 454 is transparent. In one implementation, insulating later 454 may be formed from SiO₂.

In one implementation, light encoding layer forth 32 may comprise a stack of layers formed by a polymethylmethacrylate (PMMA) substrate, a patterned opaque layer formed from an opaque aluminum I and an insulating layer of SiO2. In implementations where patterned opaque layer 452 is formed from a nonmetallic or non-electric conductive opaque material, insulating layer 454 may be omitted. In other implementations, light encoding layer 432 may comprise a diffuser or a substrate having an in homogenous optical density.

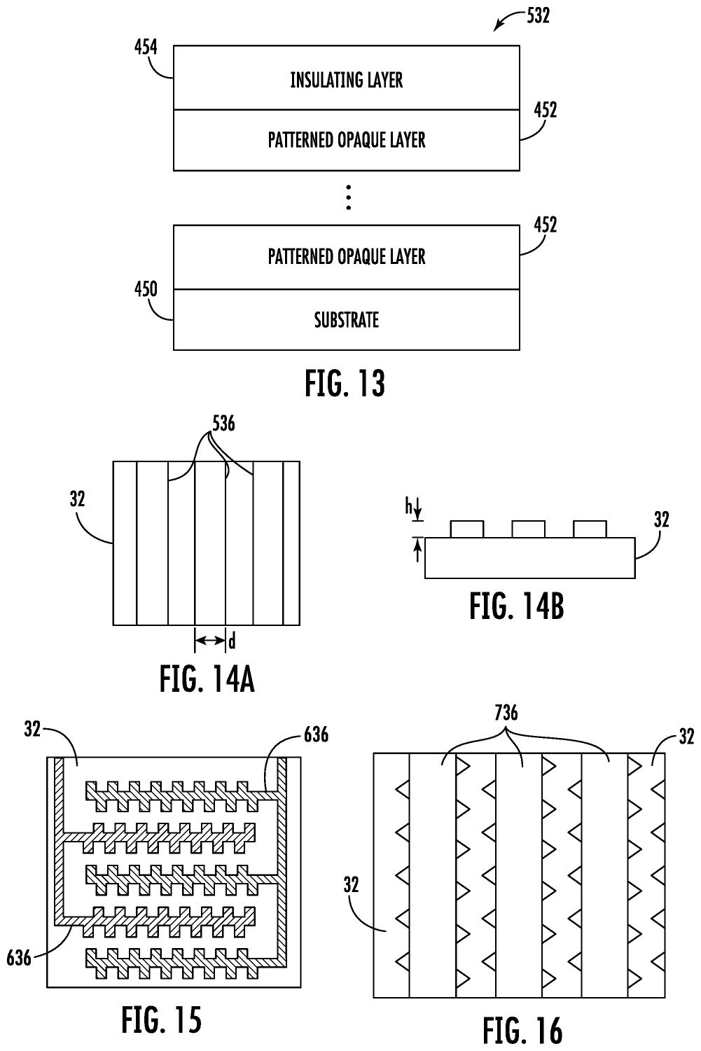

FIG. 13 is a side view schematically illustrating an example light encoding layer 532. Light encoding layer 532 is similar to light encoding layer 432 described above except that light encoding layer 532 comprises multiple masks or multiple patterned opaque layers 452 to facilitate dark-field imaging. This can be done by implementing the multiple masks in a way that their total transmission in the perpendicular (illumination) direction is minimized, while the oblique collection is maximized. Those remaining components of light encoding layer 532 which correspond to light encoding layer 432 are numbered similarly.

FIGS. 14A and 14B illustrate an example set of electrodes 536 formed on an underlying light encoding layer 32. As should be appreciated, set of electrodes 536 may likewise be formed on any of the above described light encoding layers 432 and 532 with any of the various example patterns 452-1, 452-2, 452-3, 452-4, 452-5 or 452-6. In the example illustrated, electrodes 536 comprise line electrodes extending parallel to one another and across light encoding layer 32. The parallel edges of such line electrodes 536 enhances image reconstruction of the particle. In one implementation, to enhance the rotation of a particle, such as a cell, induced by electric field formed by the electrodes, electrodes 536 are spaced by a distance d of 5 to 15 times the anticipated diameter of the particle. In one implementation, each electrode has a width of at least 100 um and no greater than 1 mm. In one implementation, each of the electrodes 536 has a height h of at least 50 nm and no greater than 100 nm.

FIG. 15 is a top view of an example set of electrodes 636 formed on an underlying light encoding layer 32. As should be appreciated, set of electrodes 636 may likewise be formed on any of the above described light encoding layers 432 and 532 with any of the various example patterns 452-1, 452-2, 452-3, 452-4, 452-5 or 452-6. Electrodes 636 are similar to electrodes 536 described above except electrodes 636 have a castellation pattern as shown. The castellation pattern may enhance the ability of the electric field formed by electrodes 636 (at different charges) to draw particles, through electrophoresis, towards the underlying light encoding layer 32 and the photosensitive layer 28 or 228 (shown in FIGS. 1 and 3).

FIG. 16 is a top view of an example set of electrodes 736 formed on an underlying light encoding layer 32. As should be appreciated, set of electrodes 636 may likewise be formed on any of the above described light encoding layers 432 and 532 with any of the various example patterns 452-1, 452-2, 452-3, 452-4, 452-5 or 452-6. Electrodes 736 are similar to electrodes 536 described above except electrodes 736 have a sawtooth pattern as shown. The sawtooth pattern may enhance the ability of the electric field formed by electrodes 736 (at different charges) to draw particles, through electrophoresis, towards the underlying light encoding layer 32 and the photosensitive layer 28 or 228 (shown in FIGS. 1 and 3).

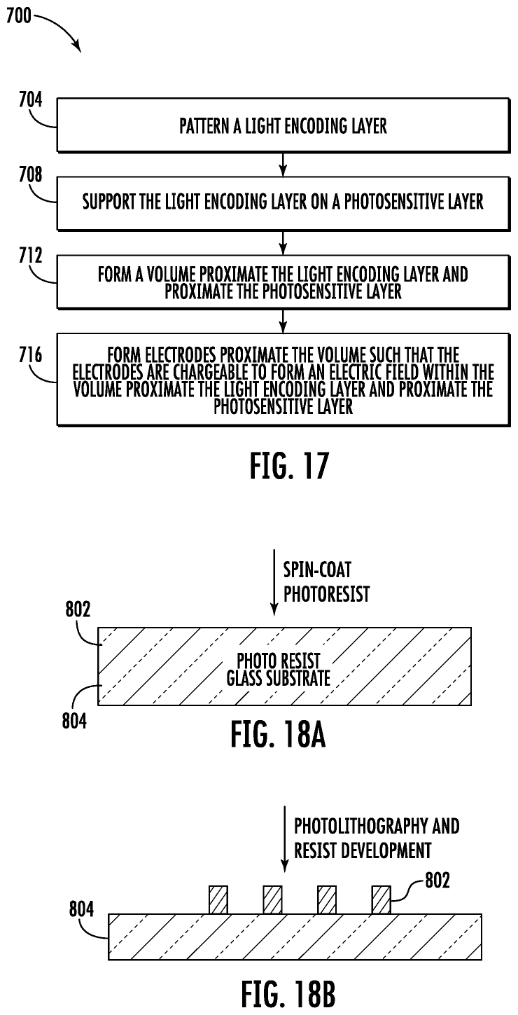

FIG. 17 is a flow diagram of an example method 700 for fabricating or forming a particle monitor, such as particle monitor 20 or 220. As indicated by block 704, a light encoding layer, such as light encoding layer 32, 432 or 532, is patterned. Such patterning may be achieved with a photoresist and selective etching of an opaque material, such as an opaque aluminum. Examples of the pattern that may be formed are illustrated and described above with respect to FIGS. 7-12.

As indicated by block 708, the light encoding layer is supported on a photosensitive layer, such as photosensitive layer 28 or 228 (shown and described above with respect to FIG. 1 or FIG. 3). In one implementation, the light encoding layer is patterned while being supported by the photosensitive layer. In another implementation, the light encoding layer is patterned and formed prior to being secured on the photosensitive layer.

As indicated by block 712, the volume, such as volume 24 described above, is formed proximate the light encoding layer and proximate the photosensitive layer. The volume may be formed by molding, material removal processes or the selective application of layers so as to form a reservoir passage forming the volume. The volume is to contain a fluid in which the particle to be analyzed are contained.

As indicated by block 716, electrodes, such as electrodes 36, 36′, 536, 636 or 736 are formed proximate the volume such that the electrodes are chargeable to form an electric field within the volume proximate the light encoding layer and proximate the photosensitive layer. In one implementation, such electrodes may be formed by deposition and selective controlled etching. In one implementation, the electrodes are formed between the volume and the light encoding layer, wherein the electrodes are transparent or otherwise transmit the light or electromagnetic radiation which passes within the volume to the photos sensitive layer. In one implementation, electrodes are formed with the volume 24 being between the electrodes and the light encoding layer.

In one implementation, the electrodes are formed so as to form an electric field within the volume that draws the particle or particles towards the light encoding layer and the photosensitive layer. In one implementation, elections are formed so as to form an electric field within the volume that rotates the particles, such as through electrophoresis. In one implementation, electrodes comprise parallel lines of electrodes. In yet other implementations, electrodes may be formed as castellations or may be saw-toothed.

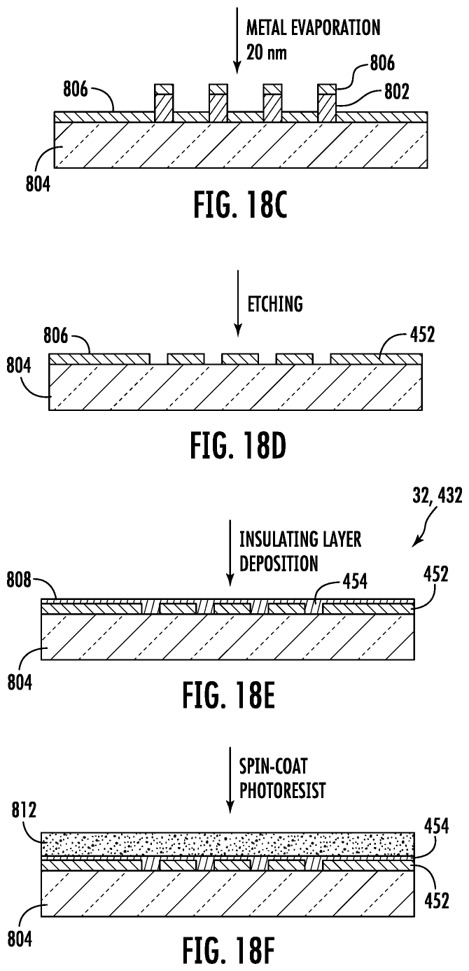

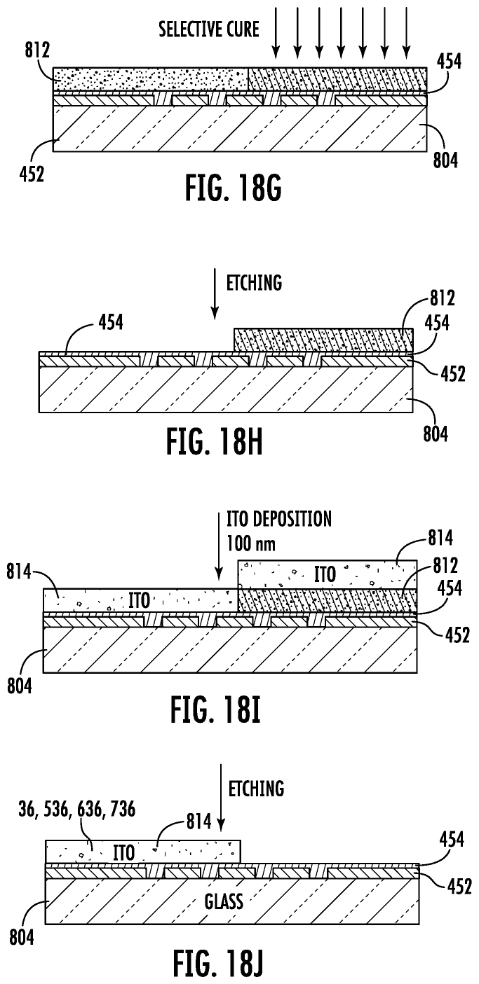

FIGS. 18A-18J are sectional views illustrating an example method for fabricating a particle monitor, such as particle monitor 20 or 220. As shown by FIG. 18A, a photoresist layer 802 is deposited upon transparent substrate, such as a glass substrate 804. In the example illustrated, the photoresist is applied by spin coating the photoresist onto the glass substrate 804. FIG. 18B illustrates the use of photolithography and resist development to form a pattern of the photoresist layer 802. The pattern of the photoresist layer 802 is a negative of the pattern of the light encoding layer to be formed.

As shown by FIG. 18C, an opaque material 806 which is to form the pattern opaque layer of the light encoding layer is deposited on the patterned photoresist layer 802. In the example illustrated, the opaque material 806 may comprise an opaque metal, such as aluminum. In the example illustrated, the opaque material 806 is deposited by metal evaporation and has a thickness of approximately 20 nm. As shown by FIG. 18D, the patterned photoresist layer 802 (shown in FIG. 18C) is removed through etching, leaving the remaining opaque material 806 which forms the patterned opaque layer 452 on top of the glass substrate 804. As shown by FIG. 18E, insulation material 808 is a deposited upon the patterned opaque layer 452 to form the insulating layer 454, completing the example light encoding layer 32, 432.

FIGS. 18F-18J illustrate the forming of the electrodes 36, 536, 636, 736 on the example light encoding layer 32, 432. FIG. 18F illustrates the forming of a photoresist layer 812 on top of the insulating layer 454. In one implementation, layer 812 comprises a photoresist which is spin coated on top of layer 454. In other implementations, layer 812 may be formed in other manners on layer 454.

As shown by FIG. 18G, the photoresist layer 812 is selectively cured followed by etching as shown in FIG. 18H. The remaining photoresist layer 12 forms a negative pattern of the pattern of electrodes being formed. As shown by FIG. 18I an electrically conductive material is deposited upon the photoresist layer 812 and the exposed layer 454. In the example illustrated, the electrically conductive layer comprises a transparent electric conductive layer 814, such as indium tin oxide. In the example illustrated, the indium tin oxide is formed by deposition and has a thickness of approximately 100 nm. As shown by FIG. 18J, the underlying patterned photoresist layer 812 (shown in FIG. 18I) is removed through etching (along with the overlying portions of the electrically conductive layer 814), leaving the patterned electrically conductive layer 814 which forms the electrodes 36, 536, 636, 736. Although one electrode is shown, it should be appreciated that the same process forms multiple electrodes comprise multiple spaced electrodes that are chargeable to distinct electrical charges so as to form the electrical field.

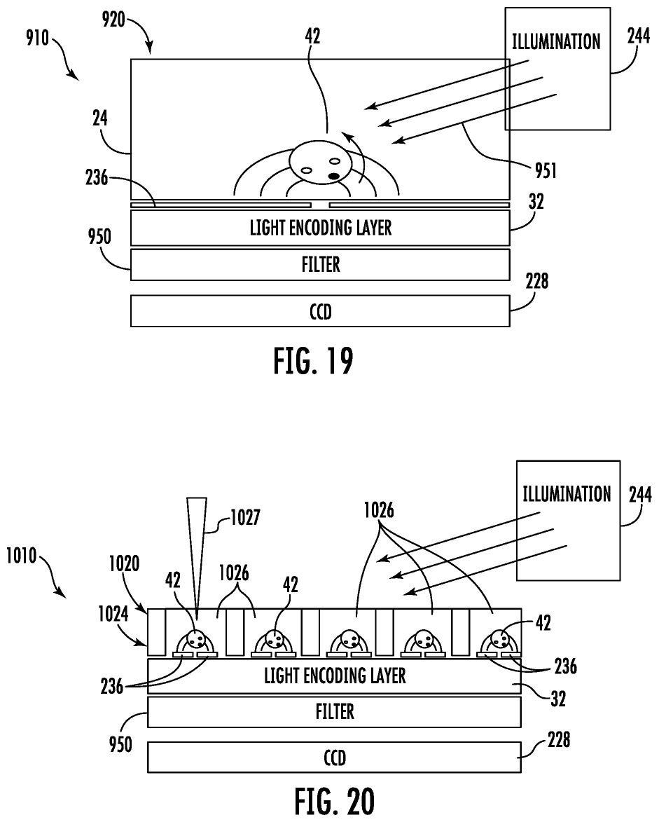

FIG. 19 is a sectional view schematically illustrating portions of an example particle monitor 920 which may be part of an example particle monitoring system 910 additionally comprise a classifier 222 shown and described above. Particle monitor 920 may be utilized in place of particle monitor 220 with respect to system 210 as described above. Particle monitor 920 is similar to particle monitor 220 except a particle monitor 920 additionally comprises filter layer 950. Those remaining components of particle monitor 920 which correspond to components of particle monitor 220 are numbered similarly.

Filter layer 950 filters selected wavelengths of the light 951 from illumination source 244. Filter layer 950 facilitates selective spectral imaging or fluorescence imaging of the particle 42. In one implementation, filter layer 950 comprises a dichroic filter which can be fabricated directly on the back-side of the substrate of the light encoding layer 32. These can be made with alternating layers of materials with different refractive indexes of controlled thickness, with a total thickness up to a few 100 nm. Although filter layer 950 is illustrated as being between light encoding layer 32 and photosensitive layer 228, in other implementations, filter layer 950 may be between light encoding layer 32 and volume 24.

FIG. 20 is a sectional view schematically illustrating portions of an example particle monitor 1020 which may be part of an example particle monitoring system 1010 additionally comprising classifier 222 shown and described above. Particle monitor 1020 may be utilized in place of particle monitor 220 with respect to system 210 as described above. Particle monitor 1020 is similar to particle monitor 920 except a particle monitor 1020 comprises volume 1024 in place of volume 24. Those remaining components of particle monitor 1020 which correspond to components of particle monitor 220 and 920 are numbered similarly.

Volume 1024 comprises a series or array of independent or isolated wells 1026 which serve as distinct reaction chambers. Each of the wells 1026 is to contain particles 42 in different conditions so as to fill facilitate studying of the response of the distinct particles 42 to the different conditions simultaneously or concurrently across the photosensitive layer 228. Each of the wells 1026 comprises a set of electrodes 236 which are chargeable to distinct charges to form an electric field within particular associated well 1026. In one implementation, each of the sets of electrodes 236 may be set at the same charge at the same time to apply the same electric field to each of the particles 42 contained within each of the wells 1026.

In another implementation, different sets of electrodes 236 may be concurrently charged to different charge differentials or may be concurrently charged at different electrical frequencies to facilitate the study of how the same particle or different particles react to such different charge differentials or different electrical frequencies in a more efficient manner. As schematically shown, in some implementations, system 1010 may additionally include a dispenser 1027 are controllably and selectively depositing particles, such as cells, within the different wells 1026. In some implementations, the dispenser 1027 may selectively and controllably deposit different chemical solutions or compositions into the different wells 1026 to facilitate multiple conditions in the different wells 1026.

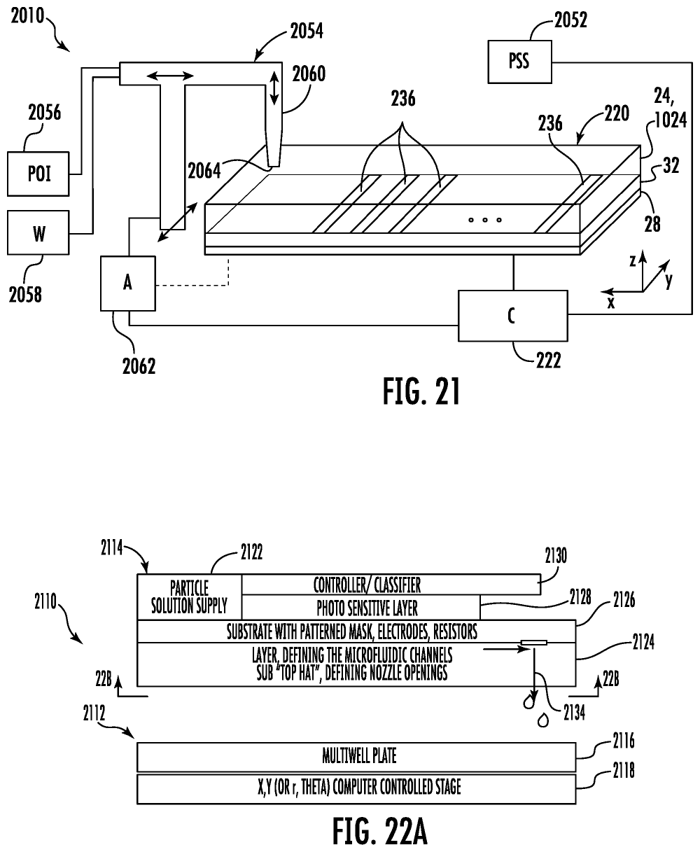

FIG. 21 is a perspective view schematically illustrating portions of an example particle monitoring system 2010. Particle monitoring system 2010 comprises particle monitor 220 and classifier 222 (described above). Particle monitoring system 2010 additionally comprises particle solution source 2052, particle extractor 2054, particles of interest chamber 2056 and waste chamber 2058.

Particle solution source 2052 comprises a reservoir that contains or a fluid passage to direct the flow of a solution containing particles of interest, potentially intermingle with other particles suspended in a liquid. Particle solution source 2052 selectively dispenses the solution containing the particles into volume 24 under the controller of classifier 222. In one implementation, volume 24 may alternatively comprise volume 1024 and part solution source 2052 may alternatively comprise dispenser 1027 as described above.

Particle extractor 2054 comprises a device to selectively extract particles from different portions of volume 24 (or volume 1024). In the example illustrated, particle extractor 2054 comprises a pipetting robot or picker arm that selectively extracts particles of interest identified by classifier 222 from volume 24, 1024. Particle extractor 2054 comprises particle vacuum tube 2060 and actuator 2062.

Particle vacuum tube 2060 comprise a tube through which a vacuum or suction is applied to vacuum or suck solution and particles from selected portions of volume 24, 1024 and to deposit the solution in either a particle of interest chamber 2056 or the waste chamber 2058. Chambers 2056 and 2058 may comprise reservoirs or may comprise fluid passages through which particles are directed to downstream destinations. Particle vacuum tube 2060 is selectively positionable opposite to selected regions of volume 24, 1024 by actuator 2062.

Actuator 2062 may position the tip of the nozzle 2064 opposite selected particles within volume 24, 1024. In the example illustrated, actuator 2062 positions nozzle 2064 is controllably moved and positioned in both the X and Y dimensions of volume 24. In other implementations, actuator 2062 may be operably connected to volume 24, 1024 (as shown in broken lines) instead of extractor 2054, wherein associated actuator 2062 selectively positions particular portions of volume 24 opposite to nozzle 2064.

In addition to classifying different particles contained in volume 24, 1024, such as a according to method 300 described above, classifier 222 comprises a controller for controlling particle solution source to 052 and extractor 2054. In one example operation protocol, classifier 222 outputs signals causing particle solution source 2052 to dispense the dilute suspension of particles, such as cells, into volume 24, 1024. In some implementations, extractor 2054 may additionally be used to dispense the particle containing solution in volume 24 or in the wells 1026 of volume 1024. The solution is deposited in sufficient volume so as to cover the floor or bottom of volume 1024 or the wells 1026 of volume 1024. In one implementation, solutions a positive such that statistically the number of particles is such that the spacing of the particles on the electrode edges is a greater than 1.5 times the diameter of the particles.

Following dispensing of the solution into volume 24, 1024, classifier 222 outputs signals causing electrodes 236 to be charged to form an electric field. Thereafter, as described above with respect to method 300, classifier 222 carries out imaging across an electric field (frequency) sweep. Such analysis may identify those particles/cells of interest. Once a particle of interest has been identified by classifier 222, classifier 222 outputs control signals actuator 2062 locating nozzle 2064 across those identified particles of interest, wherein controller 222 outputs control signals further causing a vacuum to be applied through nozzle 2064 to collect the particle of interest or each particle of interest (if any) in volume 24 or volume 1024. In one implementation, during such collection, the electric field applied by electrodes 2036 is turned off. In another implementation, the electric field is maintained or adjusted so as to retain the particles interest in place until such particles of interest are extracted by extractor 2054. The extracted particles of interest may be dispensed or directed to the particle of interest chamber 2056. After such collection, volume 24, 1024 may be washed with a wash solution. In one implementation, the wash solution may be extracted from volume 24, 1024 and deposited in waste chamber 2058 using extractor 2054. This process may be repeated as desired.

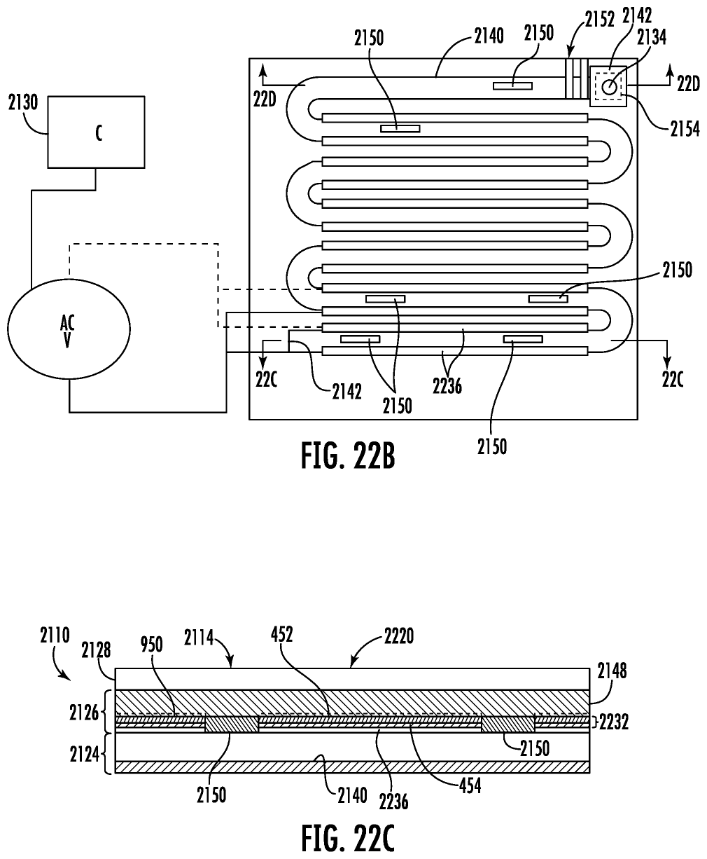

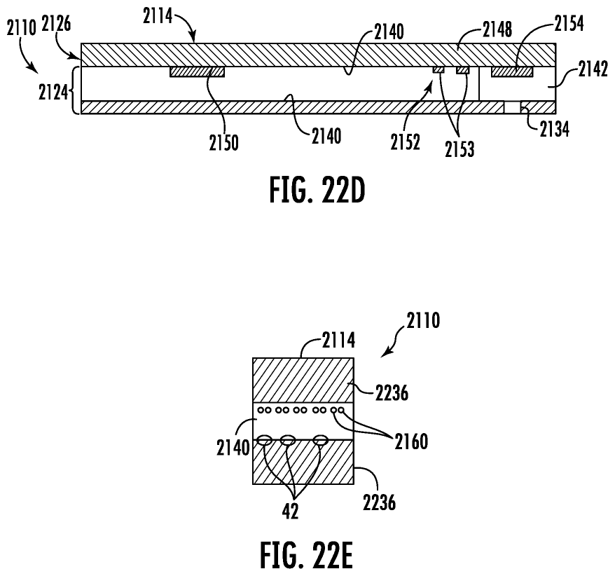

FIGS. 22A, 22B, 22C, 22D and 22E illustrate portions of an example particle monitoring system 2110. FIG. 22A is a sectional view of system 2110. FIG. 22B is a bottom view schematically illustrating portions of particle identifier and dispenser 2114. FIG. 22C is a sectional view of system 2110 taken along line 22C-22C of FIG. 22B. FIG. 22D is a sectional view of system 2110 taken along line 22E-22D of FIG. 22B. FIG. 22E is an enlarged view of particle identifier and dispenser 2114 was in the region 22E in FIG. 22B. Particle monitoring system 2110 identifies or classifies particles suspended in a solution and selectively deposits particles in a multi-well plate based upon the identification. Particle monitoring system 2110 comprises particle receiver 2112 and particle identifier and dispenser 2114.

Particle receiver 2112 receives particles that have been classified identified by particle identifier and dispenser (PID) 2114. Receiver 2112 comprises multi-well plate 2116 and stage 2118. Multi-well plate 2116 contains different wells for receiving the identified or classified particles dispensed from PID 2114.

Stage 2118 comprises an actuator to selectively position the multi-well plate 2116 based upon X, Y coordinates or r, theta (rotational) coordinates to selectively position individual wells opposite to a dispensing port of PID 2114. In other implementations, stage 2118 may be omitted where plate 2116 is stationary and PID 2114 is alternatively controllably positioned relative to the underlying individual wells of plate 2116.

PID 2114 identifies or classifies particles suspended in a solution and selectively dispenses the identified or classified particles in plate 2116 by coordinating the timing at which the identified particles are dispensed with respect to the positioning of plate 2116 and its individual wells. PID 2114 provides a self-contained and integrated microfluidic system for the continuous flow of solution containing particles being identified and for the dispensing of identified particles into the multi-well plate 2116. PID 2114 comprises particle solution supply 2122, fluid flow portion 2124, encoding and fluid driving portion 2126, photosensitive portion 2128 and controller/classifier 2130.

Particle solution supply 2122 supplies a liquid or solution containing or potentially containing particles to be identified or classified by system 2110. Such a solution may contain both particles of interest mixed with other particles. In one implementation, particle solution supply 2122 may comprise layers that are molded about or over the remaining components of PID 2114 and which form fluid supply passages connected to fluid flow portion 2124.

Fluid flow portion 2124 comprises a series of passages and/or chambers that direct the flow of the particle containing solution or fluid across encoding and fluid driving portion 2126 and across photosensitive portion 2128 to fluid dispensers or nozzles 2134 provided by portion 2124. As shown by FIG. 22B, the example PID 2114 has a fluid flow portion 2124 that comprises a serpentine flow passage 2140 having an inlet 2142 connected to the particle solution supply 2122 to receive the solution and potentially containing the particles being identified are classified. Passage 2140 terminates at a dispensing or ejection chamber 2142 which is adjacent to dispensing nozzle 2134.

In one implementation, fluid flow portion 2124 comprises at least one layer of a transparent photoresist epoxy, such as SU8, which is patterned to form the microfluidic flow passages 2140. In the example illustrated, the photoresist epoxy, such as SU8, is patterned through photolithography and etching to form flow passage 2140, chamber 2142 and dispensing nozzle 2134. In other implementations, fluid flow portion 2124 may be formed from other materials and the fluid flow passages 2140, chambers 2142 and dispensing nozzles 2134 may be formed in other fashions.

Encoding and fluid driving (EFD) portion 2126 generally comprises a substrate upon which fluid driving and ejecting or dispensing resistors, the light encoding layer or mask, light filters and particle manipulating electrodes are supported proximate to fluid flow passages 2140 and dispensing chambers 2142. EFD portion 2126 comprises substrate 2148, pumps 2150, particle counter 2152, fluid actuator 2154, light encoding layer 2232, and electrodes 2236. Substrate 2148 comprises a transparent dielectric platform upon which pumps 2150, particle counter 2152, fluid actuator 2154, light encoding layer 2232 and electrodes 2236 are formed. Substrate 2148 may further support electrically conductive lines or traces by which such components are powered or otherwise actuated. In one implementation, substrate 2148 comprises a glass or PMMA substrate. In other implementations, substrate 2140 may be formed from other transparent substrate materials.

Pumps 2150 are formed upon substrate 2148. Pumps 2150 displays fluid along flow passage 2140 the move fluid from inlet 2142 to dispensing nozzle 2134. In the example illustrated, pumps 2150 each comprise an inertial pump driven by fluid actuator. In the example illustrated, each of pumps 2150 comprises a fluid actuator in the form of a thermal resistor formed upon substrate 2148 which, upon receiving electrical current, heats to a temperature above the nucleation temperature of the solution so as to vaporize a portion of the adjacent solution or fluid to create a bubble which displaces fluid along flow passage 2140 and which forms an inertial pump for moving fluid through flow passage 2140. Although six fluid pumps 2150 are illustrated, in other implementations, a few or greater of such fluid pumps 2150 may be utilized. In other implementations, pumps 2150 may utilize other types of fluid actuators for serving as the inertial pumps.

Particle counter 2152 is situated along flow passage 2140. Particle counter 2152 is to count particles as a past particle counter 2152 during movement towards nozzle 2134. Particle counter 2152 is used to track particles that have been identified are classified and to coordinate the positioning of individual wells of receiver 2112 beneath nozzle 2134 such that identified or classified particles being ejected through nozzle 2134 are dispensed to an assigned well of plate 2116.

In one implementation, particle counter 2152 comprises a pair of electrodes 2153 formed on substrate 2148 which form an electrical field in which identify the presence of the particle passing across or through the field based upon impedance changes. For example, in one implementation, particle counter 2152 may comprise a Coulter counter. In other implementations, particle counter 2152 may comprise an optical sensor/counter or other devices for sensing the presence are passage of a particle.

Fluid actuator 2154 comprises a mechanism formed upon substrate 2148 within rejection chamber 2142 that, upon being actuated, displaces fluid or is the solution through nozzle 2134. In one implementation, fluid actuator 2154 comprises a thermal resistor formed upon substrate 2148 which, upon receiving electrical current, heats to a temperature above the nucleation temperature of the solution so as to vaporize a portion of the adjacent solution or fluid to create a bubble which displaces fluid through nozzle 2134. In other implementations, fluid actuator 2154 may comprise other forms of fluid actuators. In other implementations, fluid actuator 2154 as well as the fluid actuators employed as part of pumps 2150 may comprise fluid actuators in the form of a piezo-membrane based actuator, and electrostatic membrane actuator, mechanical/impact driven membrane actuator, a magnetostrictive drive actuator, and electrochemical actuator, and external laser actuators (that form a bubble through boiling with a laser beam), other such microdevices, or any combination thereof.

Light encoding layer 2232, electrodes 2236 and photosensitive layer 2128 form a particle monitor similar to particle monitors 20 and 220 described above. Light encoding layer 2232 may comprise a light encoding layer similar to light encoding layer 452 or 532 as described above, where substrate 2148 corresponds to substrate 450 and where light encoding layer 2232 further comprises patterned opaque layer 452 and insulating layer 454 (described above). Patterned opaque layer 452 may comprise any of the patterns illustrated in FIGS. 7-12 or other light encoding patterns. As shown in broken lines, in some implementations, a filter, such as filter 950 described above, may be formed adjacent light encoding layer 2232. In some implementations, light encoding layer 2232 may comprise multiple patterned opaque layers 452 as shown and described above with respect to light encoding layer 532.

Electrodes 2236 are similar to electrodes 36 described above in that electrodes 2236 comprise transparent electrically conductive structures arranged in pairs or sets and which are placed at different electrical charges so as to form an electrical field within passage 2140. In one implementation, electrodes 2236 may be formed from a transparent electrically conductive material such as indium tin oxide. In other implementations, electrodes 2236 may be formed from other transparent electrically conductive materials. In the example illustrated, electrodes 2236 are formed upon substrate 2148 above and on opposite sides of a corresponding portion of flow passage 2140. In the example illustrated, six pairs of electrodes 2236 are formed along six different linear segments of the serpentine flow passage 2140. As a result, particles may be identified and classified along each of the six linear segments of the serpentine flow passage 2140. The serpentine nature of flow passage 2140 facilitates the identification and classification particles along multiple segments in a compact arrangement, conserving valuable space. In other implementations, a greater or fewer of number of such pairs may be provided. In other implementations, flow passage 2140 may have a different path or shape.

As shown by FIG. 22E, in one implementation, the portion of the flow passage 2140 between electrodes 2236 may include pillars 2160 which are spaced from one another along one of electrodes 2236. Pillars 2160 inhibit particles 42, such as cells, from attaching to and spinning on the electrodes 2236.

As described above with respect to electrodes 36, the electric field formed by electrodes 2236 manipulates the particle or particles suspended within the fluid contained within the volume provided by flow passage 2140. In one implementation, the electric field is controlled so as to attract or draw the particle or particles, using electrophoresis, into closer proximity to light encoding layer 2232 and photosensitive layer 2128. Drawing the particle or particles into closer proximity with photosensitive layer 2128 provides enhanced sensing and/or imaging of the particular particle or particles.

In one implementation, the electric field is controlled so as to rotate the particle, using dielectrophoresis. Rotation of the particle or particles alters the transmission of light through light encoding layer 2232 to photosensitive layer 2128. Signals from photosensitive layer 2128 may be used to determine rotational characteristics of the particle in response to the electric field. In one implementation, the rotational response of the particle to the electric field is sensed to identify or classify the particle or is used to distinguish the particle from other particles. In some implementations, the rotation response of the particle to different electric fields, such as different frequencies of an electric field, is sensed to identify or classify the particle or is used to distinguish the particle from other particles. Such identification or classification is achieved with a less reliance or without any reliance upon precision stepping, optics and/or high-sensitivity cameras.

In one implementation, light encoding layer 2232 and electrodes 2236 may be formed using the fabrication method 700. In one implementation, light encoding layer 2232 and electrodes 2236 may be formed using the fabrication method described above with respect to FIGS. 18A-18J. In yet other implementations, light encoding layer 2232 and electrodes 2236 may be formed in other fashions.

Photosensitive layer 2128 is similar to photosensitive layer 28 described above. Photosensitive layer 2128 comprises a layer of material or materials that react to impinging light. Layer 2128 itself may be composed of multiple layers. In one implementation, photosensitive layer 2128 comprises an electronic light sensor referred to as a charge coupled device or CCD. The CCD may be formed from pixels such as p-doped metal-oxide-semiconductors capacitors. Such capacitors convert incoming photons in electron charges at the semi-conductor-oxide interface, were in such charges are read to detect light impingement at the individual pixels. In other implementations, photosensitive layer 2128 may comprise other layers are devices that are sensitive to the impingement of photons or light.

Controller/classifier 2130 comprises a processing unit and a non-transitory computer-readable medium that contains instructions for directing the process to (1) control the operation of fluid actuators or pumps 2150, (2) to identify and/or classify the particle based upon the sensed images and their smaller pixels as sensed by photosensitive layer 2128, (3) to control the dispensing or ejection of the identified particle through nozzle 2134 and (4) to control the positioning of multi-well plates 2116 and its wells to dispense particular identified particles into particular wells of play 2116.

In one implementation, controller/classifier 2130 may carry out the identification and classification method 300 described above with respect to FIGS. 4 and 5. Classifier 222 analyzes the images and pixels by comparing such pixels to determine rotational characteristics of particles within the different segments of flow path 2140. The rotational characteristics are compared to predetermined rotational characteristics of identified particles (stored in a database or lookup table). The particle being monitored may be classified identified as a particular type of particle in response to the particle being monitored having a rotation characteristic that is the same or substantially similar to the rotational characteristics of the prior identified particle of the particular type. As described above, some implementations, a field sweep of different charge frequencies may be applied, wherein the rotation response of the particles to the different frequencies may be evaluated to identify or classify the particles. In other implementations, image reconstruction of the particles may be utilized, along with other sensed characteristics of the particles, to identify and/or classify the particles.

In operation, a solution containing or potentially containing particles of interest is supplied to fluid flow passage 2140 via particle solution supply 2122. Controller/classifier 2130 outputs control signals actuating fluid actuators or pumps 2150 to move the fluid along fluid passage 2140, filling each of the segments that are adjacent electrodes 2236. Once fluid has filled each of such segments, the pumping fluid by fluid pumps 2150 is paused. Thereafter, electrodes 2236 are charged as signals are taken from photosensitive layer 2128 to identify and/or classify the particles within the different segments as described above. In addition, the particular relative positioning each of the identified or classified particles along flow passage 2140 is recorded by controller/classifier 2130. For example, a string or series of particles may be recorded with each particle of the series being recorded identified.

Once a classification is completed, controller/classifier 2130 actuates fluid pumps 2150 once again to move the stream of fluid containing the classified particles towards dispensing nozzle 2134. Counter 2152 counts the particles as they pass counter 2152 towards dispensing nozzle 2134. Based upon signals from counter 2152 and the previously determined order of the classified and/or identified particles in the string or series of particles along flow passage 2140, controller/classifier 2130 determines which particle is within chamber 2142 and is ready for being dispensed at any particular time. Using such information, controller/classifier 2130 outputs control signals to stage 2118, linearly positioning or rotating multi-well plates 2116 to position a selected one of the wells of multi-well plate 2116 directly beneath nozzle 2134 for receiving a particle having a determined classification or identity.

Once the particular well is positioned beneath nozzle 2134, controller/classifier 2130 outputs control signals to fluid actuator 2154, causing fluid actuator 21542 dispense the particular particle through nozzle 2134 into the selected well. For each of such wells, controller/classifier 2130 stores information regarding what particular classified/identified particle is stored within the well. For example, controller/classifier 2130 may store data indicating that particle X is in well 1, particle Y is in well 2 and so on.

Although the present disclosure has been described with reference to example implementations, workers skilled in the art will recognize that changes may be made in form and detail without departing from the scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A particle monitoring system comprising:
a volume to contain a fluid in which particles are suspended;
a photosensitive layer;
a light encoding layer sandwiched between the volume and the photosensitive layer; and
electrodes to apply an electric field to the fluid within the volume and proximate the photosensitive layer.

2. The system of claim 1, wherein the electrodes are sandwiched between the light encoding layer and the volume and wherein the electrodes are transparent.

3. The system of claim 1, wherein the volume is sandwiched between the electrodes and the light encoding layer.

4. The system of claim 1, wherein the volume comprises distinct wells.

5. The system of claim 1 comprising an AC power source connected to the electrodes such that the electric field rotates particles while the particles are suspended proximate the photosensitive layer.

6. The system of claim 1 further comprising an optical filter sandwiched between the light encoding layer and the photosensitive layer.

7. The system of claim 1 further comprising a controller to receive signals from the photosensitive layer and to classify the particles based upon the received signals.

8. The system of claim 7, wherein the controller is to classify particles based upon a rotation of the particles determined from the received signals.

9. The system of claim 8, wherein the controller is to output signals causing the electric field to be applied with different frequencies, wherein the controller is to classify the particles based upon rotation responses to the different frequencies.

10. The system of claim 7, wherein the controller is to output control signals so as to apply a first electric field to the particles to rotate the particles for rotation sensing and a second electric field, different than the first electric field, to the particles to retain the particles against the electrodes for particle reconstruction.

11. The system of claim 1, wherein the volume comprises a channel through which the fluid may flow, the system further comprising:
an inertial pump to displace fluid along the channel; and
a fluid ejector to selectively eject fluid from the channel.

12. A particle monitoring method comprising:
supplying a volume of fluid containing a suspended particle;
applying an electric field to the suspended particle;
sensing light, that has passed through the electric field, around the suspended particle and through a light encoding layer, with a photosensitive layer.

13. The particle monitoring method of claim 12 further comprising:
determining a rotation of the suspended particle based upon the sensing of the light; and
classifying the particle based at least in part upon the determined rotation.

14. A particle monitoring device fabrication method comprising:
patterning a light encoding layer;
supporting the light encoding layer on a photosensitive layer;
forming a volume proximate the light encoding layer and proximate the photosensitive layer; and
forming electrodes proximate the volume such that the electrodes are chargeable to form an electric field within the volume proximate the light encoding layer and proximate the photosensitive layer.

15. The particle monitoring device fabrication method of claim 14, wherein the electrodes are formed on the light encoding layer, between the light encoding layer and the volume.
